(19) United States
(12) Patent Application Publication
(10) Pub. No.: US 2026/0249571 A1
(43) Pub. Date: Aug. 27, 2026

(54) POST-PROCESSING EQUIPMENT FOR 3D-PRINTED PLASTIC PARTS AND INSTALLATION METHOD THEREOF

(71) Applicant: Suzhou REPOLY Technology Co., Ltd, Suzhou (CN)

(72) Inventors: Junjian Ye, Suzhou (CN); Zhe Xue, Suzhou (CN); Lu Cui, Suzhou (CN)

(21) Appl. No.: 19/446,541

(22) Filed: Jan. 12, 2026

(30) Foreign Application Priority Data
Feb. 24, 2025 (CN) 202510204016.2

(51) Int. Cl. B29C 71/00; B33Y 40/20

(52) U.S. Cl. CPC B29C 71/0009; B33Y 40/20; B29C 2071/0027

(57) ABSTRACT

A post-processing device for 3D-printed plastic parts and an installation method thereof are disclosed. The post-processing device includes an equipment housing having a loading chamber formed therein. A reaction chamber configured to accommodate 3D-printed plastic parts is disposed within the loading chamber and is provided with a chamber cover. A retaining assembly is arranged in the loading chamber to secure the reaction chamber. A lower portion of the reaction chamber is fluidly connected to a recovery chamber via a connecting pipe, and the recovery chamber is configured to collect solvent vapor generated in the reaction chamber. A connecting assembly is provided on the recovery chamber, such that when the reaction chamber is secured in the loading chamber by the retaining assembly, the reaction chamber is simultaneously brought into fluid communication with the recovery chamber. The disclosed configuration simplifies installation of the reaction chamber and improves installation efficiency and reliability.

### TECHNICAL FIELD

The present invention relates to post-processing equipment for 3D-printed plastic parts, and an installation method thereof.

### BACKGROUND

With the continuous development and scaled application of 3D printing technology in the field of plastic part manufacturing, post-processing polishing has gradually become an indispensable key processing step in the manufacture of 3D-printed products. After chemical vapor smoothing, a surface quality close to that of injection-molded parts can be achieved, and the physical and mechanical properties of the parts can also be improved to a certain extent.

In the global market, two post-processing vapor smoothing equipments occupying more than 90% market share are respectively from AMT in the United Kingdom and DyeMansion in Germany. The core mechanical structure of AMT includes a dual-chamber structure plus a quick vacuum door, a heating evaporator, and a large-air-volume annular circulating air duct. The equipment of DyeMansion is a single-chamber structure including an evaporator plus an atomization system (Aerosol VFS system) and a fully closed-loop solvent circulation. Both equipments include vacuum and temperature control modules. From the viewpoint of part processing results, complex mechanical structures and the manner of generating high-temperature vapor are the main reasons leading to processing failures. From the viewpoint of equipment manufacturing, the equipment structures are complex and the installation steps are relatively cumbersome.

In addition, the fixing and connecting manner of the reaction chamber is not sufficiently simple and fast. The reaction chamber is commonly fixed by mechanical connection manners such as bolts and latches. Such connection manners require precise alignment and tightening, and improper operation may cause the reaction chamber to be fixed insecurely. During post-processing, the reaction chamber may become loose due to vibration or other external forces, thereby affecting processing results and safety.

Accordingly, there is a need for post-processing equipment for 3D-printed plastic parts and an installation method thereof.

### SUMMARY

The present invention provides post-processing equipment for 3D-printed plastic parts and an installation method thereof, so as to address one or more of the problems set forth above.

In one aspect, the present invention provides a reminder that a post-processing equipment for 3D-printed plastic parts comprises an equipment housing (1). A loading chamber (101) is formed inside the equipment housing (1). A reaction chamber (2) for loading 3D-printed plastic parts is arranged in the loading chamber (101). A chamber cover (3) is arranged at an upper portion of the reaction chamber (2). The loading chamber (101) is provided with a retaining assembly (4) for fixing the reaction chamber (2).

A lower portion of the reaction chamber (2) is connected to a recovery chamber through a connecting pipe (5). The recovery chamber is used for recovering solvent vaporized in the reaction chamber (2). A connecting assembly (6) is arranged on the recovery chamber, so that the connecting pipe (5) is connected to the recovery chamber through the connecting assembly (6).

Wherein, the reaction chamber (2) is connected to the loading chamber (101) through the retaining assembly (4) and, at the same time, is communicated with the recovery chamber through the connecting assembly (6).

Preferably, the retaining assembly (4) comprises a retaining slide groove (401) formed on the loading chamber (101). A sliding plate (402) is arranged inside the retaining slide groove (401). The sliding plate (402) is connected to a carrier plate (404) through two groups of connecting rods (403). A plurality of anti-slip strips (405) are arranged on the carrier plate (404).

Preferably, an inner cavity (4021) is formed in the sliding plate (402), and a return spring (406) is arranged inside the inner cavity (4021). The return spring (406) is located directly below the connecting rods (403), so that the connecting rods (403) elastically move in the inner cavity (4021) through the return spring (406). A rolling groove (4022) is formed at a bottom of

the sliding plate (402) adjacent to the inner cavity (4021), and rolling balls (407) are embedded in the rolling groove (4022).

Preferably, a guide rolling groove (4011) for rolling of the rolling balls is formed on an inner wall of the retaining slide groove (401). A notch (4012) is formed at the retaining slide groove (401), and the notch (4012) cooperates with the carrier plate (404).

Preferably, a retaining plate (201) is arranged at an upper portion of the reaction chamber (2). The retaining plate (201) has the same shape as the carrier plate (404), and engaging grooves (202) cooperating with the anti-slip strips (405) are formed at a bottom portion of the retaining plate (201). A combined height of the sliding plate (402), the carrier plate (404), and the retaining plate (201) cooperates with a height of the retaining slide groove (401).

Preferably, the connecting assembly (6) comprises a guide cylinder (601) located in a middle portion of the equipment housing (1). A bellows (602) connected to the recovery chamber is arranged inside the guide cylinder (601). A connecting joint (603) is arranged at an upper portion of the bellows (602).

Preferably, a sealing spring (604) is arranged between the bellows (602) and the guide cylinder (601), and the sealing spring (604) is located below the connecting joint (603).

Preferably, a receiving groove (605) cooperating with the connecting pipe (5) is formed at an upper portion of the connecting joint (603). A sealing liner (606) is arranged at the receiving groove (605). An “L”-shaped guide groove (607) is formed at the receiving groove (605), and the guide groove (607) is arranged in an arc shape. A positioning groove (6071) is formed at a tail end of the guide groove (607).

Preferably, a connecting support plate (501) is arranged on an outer periphery of the connecting pipe (5), and the connecting support plate (501) cooperates with the guide groove (607).

In another aspect, the present invention provides an installation method of the post-processing equipment for 3D-printed plastic parts, comprising the following steps: Step A: placing the reaction chamber (2) at the equipment housing (1) through the loading chamber (101), such that the retaining plate (201) of the reaction chamber (2) fits with a position of the carrier plate (404), and the retaining plate (201) is engaged to a side of the anti-slip strips (405) of the carrier plate (404) through the engaging groove (202); at this time,

the connecting pipe (5) at the lower portion of the reaction chamber (2) is inserted into the connecting joint (603) of the guide cylinder (601); Step B: pressing the reaction chamber (2) downward through the chamber cover (3), so that the retaining plate (201) presses the connecting rods (403) through the carrier plate (404), the connecting rods (403) move toward the inner cavity (4021) and press the return spring (406), and the return spring (406) is compressed until the carrier plate (404) fits to the sliding plate (402); at this time, the retaining plate (201) is located below the notch (4012) of the retaining slide groove (401); Step C: rotating the reaction chamber (2), the retaining plate (201) rotates to a tail end of the guide rolling groove (4011) through the rolling balls (407) below the sliding plate (402), and an elastic force generated by the return spring (406) presses the retaining plate (201) to fit to an inner wall of the guide rolling groove (4011), thereby completing preliminary positioning of the reaction chamber; Step D: during pressing the reaction chamber (2) downward, the connecting support plate (501) of the connecting pipe (5) presses and fits to the receiving groove (605) position of the connecting joint (603) through the guide groove (607), and presses the sealing liner (606) therein; the sealing liner (606) elastically deforms to fill and satisfy a gap between the connecting pipe (5) and the connecting joint (603); Step E: the connecting joint (603) moves downward under force to drive the bellows (602) to fold, and meanwhile the connecting joint (603) presses the sealing spring (604); the sealing spring (604) generates an elastic force and acts on the connecting pipe (5) reversely through the connecting joint (603); Step F: during rotation of the reaction chamber (2), the connecting pipe (5) follows in the guide groove (607), driving the connecting support plate (501) to rotate into the positioning groove (6071) at the tail end of the guide groove (607); positioning of the connecting pipe (5) completes secondary positioning of the reaction chamber.

Compared with the prior art, the present invention provides beneficial effects including: a simplified structure and simplified installation. The cooperation among components of the retaining assembly (4) enables installation of the reaction chamber (2) without complex alignment and without multiple mechanical connection manners such as bolts and latches. The

installation process from placing the reaction chamber (2) into the equipment housing (1) to pressing down and rotating is relatively simple and fast, thereby reducing the complexity of installation steps and reducing installation error probability. The connecting assembly (6) provides a reliable and simple connection between the reaction chamber (2) and the recovery chamber, while ensuring sealing and stability.

### DEFINITIONS (Optional)

As used herein, the following terms are intended to have the meanings set forth below unless the context clearly indicates otherwise.

“3D-printed plastic parts” refers to plastic parts fabricated by additive manufacturing processes, including but not limited to powder bed fusion, material extrusion, vat photopolymerization, material jetting, binder jetting, and sheet lamination processes, and includes parts made of thermoplastics and/or thermosets.

“Post-processing” refers to one or more operations performed after a 3D printing process to improve surface appearance, dimensional consistency, and/or mechanical performance, including chemical vapor smoothing, chemical vapor polishing, solvent vapor treatment, and related solvent-based finishing operations.

“Solvent” refers to a chemical substance used to soften, smooth, dissolve, or partially dissolve a surface layer of a plastic part during post-processing, and may be provided in liquid form and/or vapor form, and may include one or more solvents and/or additives.

“Vaporized solvent” refers to solvent present in a gaseous phase, including solvent vapor generated by heating, reduced pressure, atomization, evaporation, and/or other vapor generation mechanisms.

“Reaction chamber (2)” refers to a chamber configured to accommodate 3D-printed plastic parts and to allow the parts to be contacted by vaporized solvent during post-processing. The reaction chamber (2) may be removably installed in the loading chamber (101) of the equipment housing (1).

“Recovery chamber” refers to a chamber configured to recover vaporized solvent from the reaction chamber (2), for example by condensation, adsorption, absorption, cooling, pressure change, or any combination thereof.

“Loading chamber (101)” refers to a space within the equipment housing (1) configured to receive and support the reaction chamber (2) during installation and operation.

“Retaining assembly (4)” refers to one or more structures configured to fix and/or position the reaction chamber (2) within the loading chamber (101). In the illustrated embodiments, the retaining assembly (4) may include one or more of the retaining slide groove (401), the sliding plate (402), the connecting rods (403), the carrier plate (404), and the anti-slip strips (405), and associated components.

“Connecting assembly (6)” refers to one or more structures configured to connect the connecting pipe (5) to the recovery chamber and to provide a sealed flow path therebetween. In the illustrated embodiments, the connecting assembly (6) may include one or more of the guide cylinder (601), the bellows (602), the connecting joint (603), the sealing spring (604), the receiving groove (605), the sealing liner (606), the guide groove (607), and the positioning groove (6071), and associated components.

“Fit,” “cooperate,” “engage,” and “communicate” (including “communicated with” and “in communication with”) are used to describe functional and/or structural relationships, and may include direct interaction and/or interaction through one or more intermediate components, unless expressly stated otherwise.

The terms “include,” “including,” “comprise,” and “comprising” are used in an open-ended manner and do not exclude additional features, elements, or steps not expressly recited.

The terms “upper,” “lower,” “above,” “below,” “inside,” “outside,” “middle,” and similar positional descriptors are used for convenience of description with reference to the illustrated embodiments and do not necessarily require a particular orientation in actual use.

### BRIEF DESCRIPTION OF THE DRAWINGS

FIG. 1 is a schematic diagram of an overall structure of an embodiment of the present invention;

FIG. 2 is a schematic diagram of an equipment housing structure of an embodiment of the present invention;

FIG. 3 is a schematic diagram of a reaction chamber structure of an embodiment of the present invention;

FIG. 4 is a schematic diagram of a retaining assembly structure of an embodiment of the present invention;

FIG. 5 is a cross-sectional schematic diagram of the retaining assembly of an embodiment of the present invention;

FIG. 6 is a schematic diagram of an internal structure of an embodiment of the present invention;

FIG. 7 is a cross-sectional schematic diagram of a connecting assembly of an embodiment of the present invention;

FIG. 8 is a schematic diagram of a connecting joint structure of an embodiment of the present invention.

Reference numerals in the drawings are as follows: 1, equipment housing; 101, loading chamber; 2, reaction chamber; 201, retaining plate; 202, engaging groove; 3, chamber cover; 4, retaining assembly; 401, retaining slide groove; 4011, guide rolling groove; 4012, notch; 402, sliding plate; 4021, inner cavity; 4022, rolling groove; 403, connecting rod; 404, carrier plate; 405, anti-slip strip; 406, return spring; 407, rolling ball; 5, connecting pipe; 501, connecting support plate; 6, connecting assembly; 601, guide cylinder; 602, bellows; 603, connecting joint; 604, sealing spring; 605, receiving groove; 606, sealing liner; 607, guide groove; 6071, positioning groove.

### DETAILED DESCRIPTION

In order to facilitate addressing the problem in the prior art that installation steps of the reaction chamber are relatively cumbersome and that fixing and connecting manners of the reaction chamber are not sufficiently simple and fast, the present invention provides post-processing equipment for 3D-printed plastic parts and an installation method thereof. The technical solutions in embodiments of the present invention will be described clearly and completely below with reference to the accompanying drawings. It should be understood that the embodiments described herein are only part of the embodiments of the present invention and not all embodiments. Based on the embodiments of the present invention, all other embodiments obtained by those of ordinary skill in the art without creative work shall fall within the protection scope of the present invention.

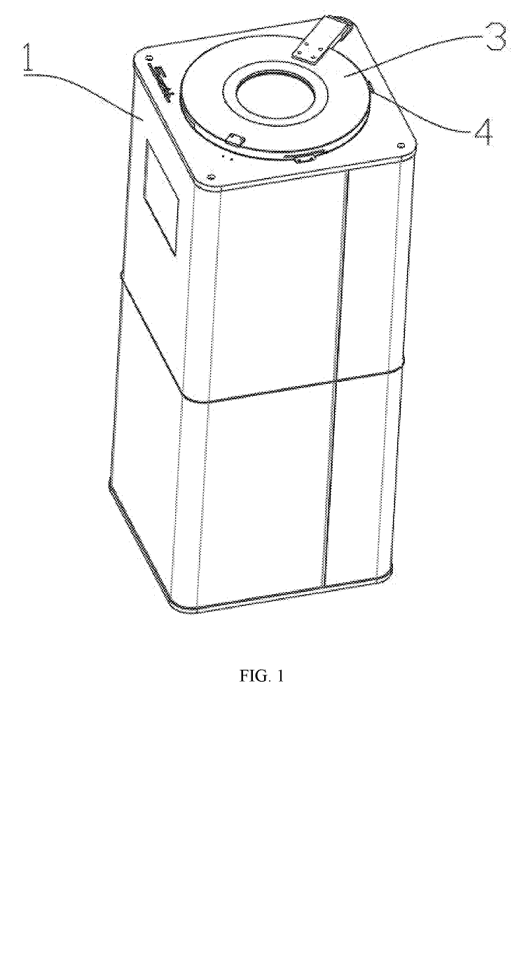

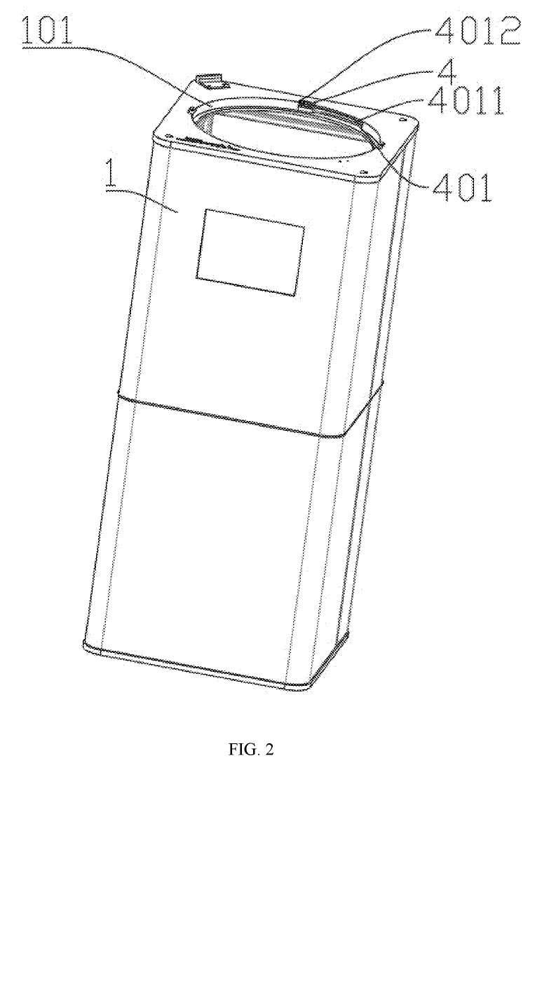

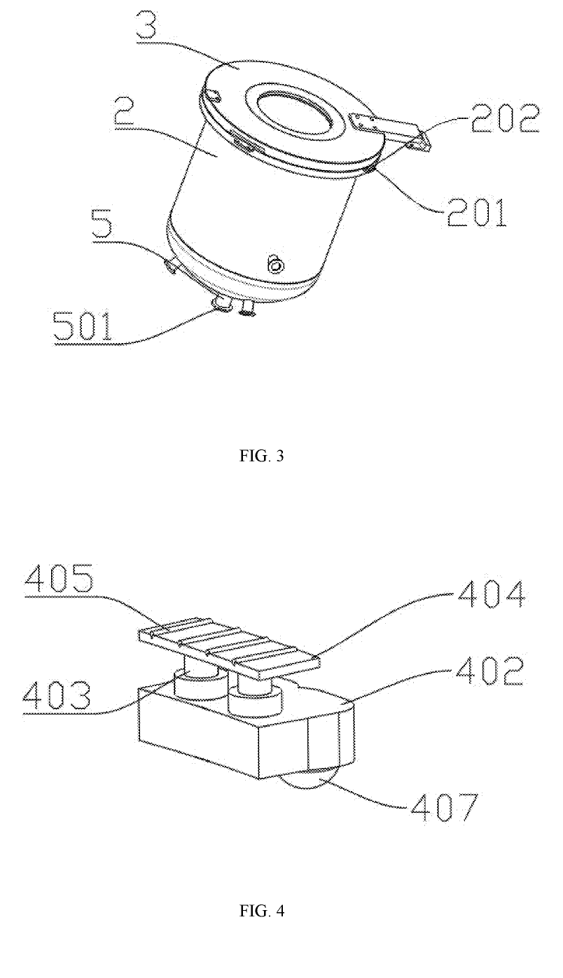

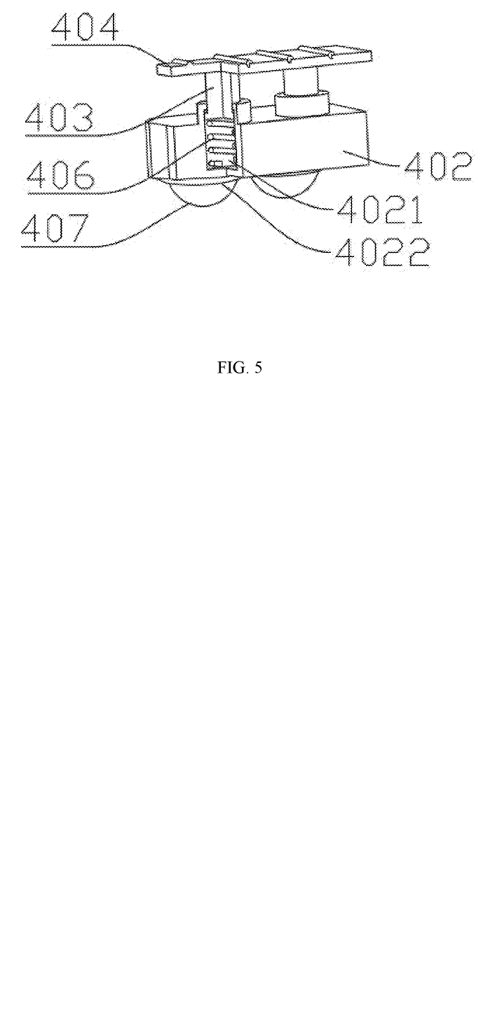

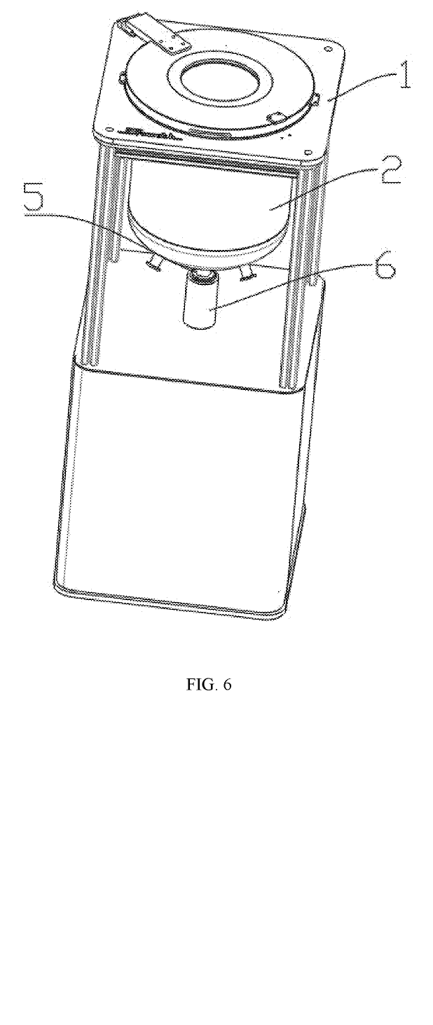

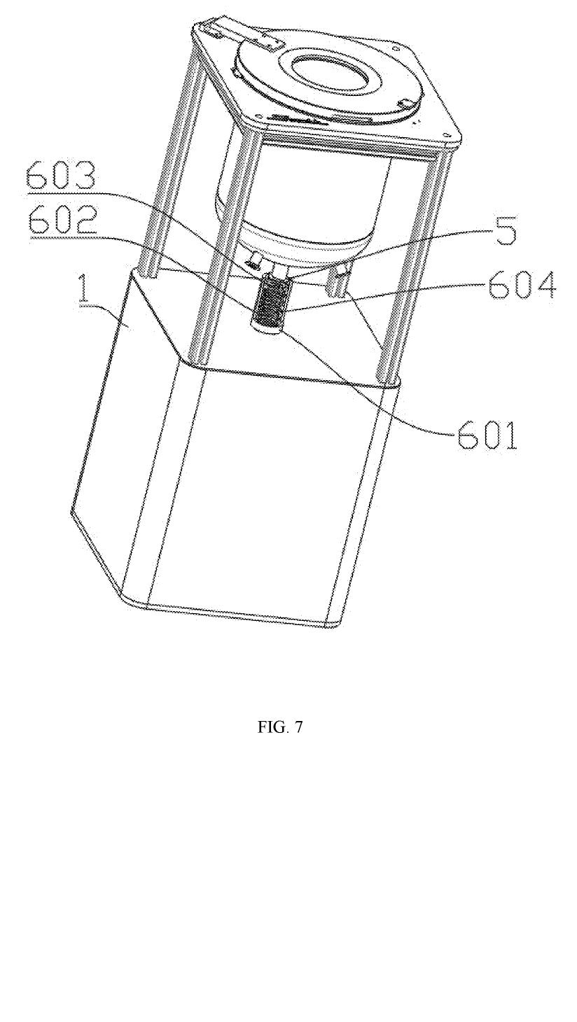

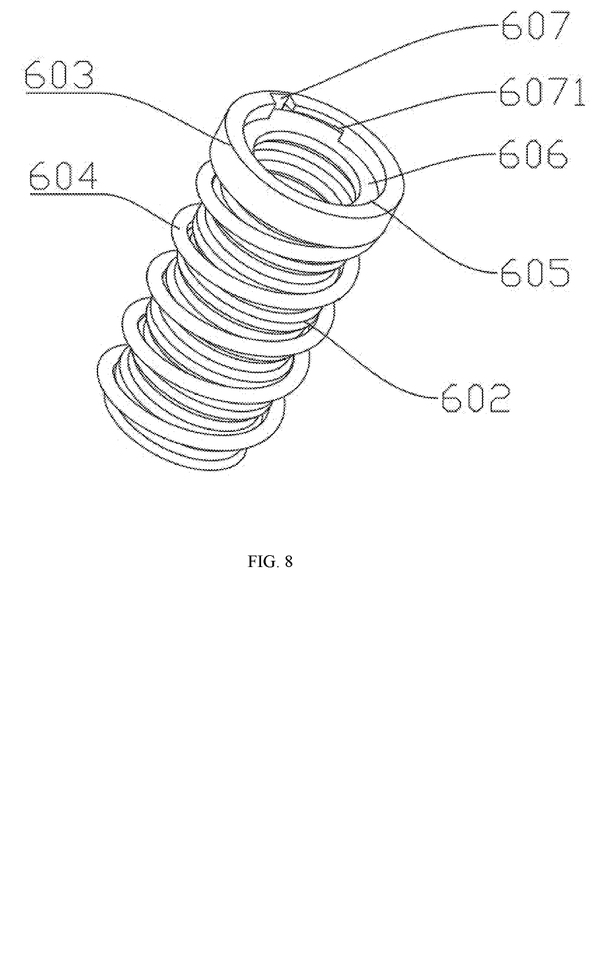

Referring to FIGS. 1–8, the present invention provides post-processing equipment for 3D-printed plastic parts, comprising an equipment housing 1. A loading chamber 101 is formed inside the equipment housing 1. A reaction chamber 2 for loading 3D-printed plastic parts is arranged in the loading chamber 101. A chamber cover 3 is arranged at an upper portion of the reaction chamber 2. The loading chamber 101 is provided with a retaining assembly 4 for fixing the reaction chamber 2.

A lower portion of the reaction chamber 2 is connected to a recovery chamber through a connecting pipe 5. The recovery chamber is used for recovering solvent vaporized in the reaction chamber 2. A connecting assembly 6 is arranged on the recovery chamber, so that the connecting pipe 5 is connected to the recovery chamber through the connecting assembly 6. Wherein, the reaction chamber 2 is connected to the loading chamber 101 through the retaining assembly 4 and simultaneously is communicated with the recovery chamber through the connecting assembly 6.

The retaining assembly 4 comprises a retaining slide groove 401 formed on the loading chamber 101. A sliding plate 402 is arranged inside the retaining slide groove 401. The sliding plate 402 is connected to a carrier plate 404 through two groups of connecting rods 403. A plurality of anti-slip strips 405 are arranged on the carrier plate 404.

An inner cavity 4021 is formed in the sliding plate 402, and a return spring 406 is arranged inside the inner cavity 4021. The return spring 406 is located directly below the connecting rods 403, so that the connecting rods 403 elastically move in the inner cavity 4021 through the return spring 406. A rolling groove 4022 is formed at a bottom of the sliding plate 402 adjacent to the inner cavity 4021, and rolling balls 407 are embedded in the rolling groove 4022.

A guide rolling groove 4011 for rolling of the rolling balls 407 is formed on an inner wall of the retaining slide groove 401. A notch 4012 is formed at the retaining slide groove 401, and the notch 4012 cooperates with the carrier plate 404.

A retaining plate 201 is arranged at an upper portion of the reaction chamber 2. The retaining plate 201 has the same shape as the carrier plate 404, and engaging grooves 202 cooperating with the anti-slip strips 405 are formed at a bottom portion of the retaining plate 201. A combined height of the sliding plate 402, the carrier plate 404, and the retaining plate 201 cooperates with a height of the retaining slide groove 401.

The connecting assembly 6 comprises a guide cylinder 601 located in a middle portion of the equipment housing 1. A bellows 602 connected to the recovery chamber is arranged inside the guide cylinder 601. A connecting joint 603 is arranged at an upper portion of the bellows 602.

A sealing spring 604 is arranged between the bellows 602 and the guide cylinder 601, and the sealing spring 604 is located below the connecting joint 603.

A receiving groove 605 cooperating with the connecting pipe 5 is formed at an upper portion of the connecting joint 603. A sealing liner 606 is arranged at the receiving groove 605. An “L”-shaped guide groove 607 is formed at the receiving groove 605, and the guide groove 607 is arranged in an arc shape. A positioning groove 6071 is formed at a tail end of the guide groove 607.

A connecting support plate 501 is arranged on an outer periphery of the connecting pipe 5, and the connecting support plate 501 cooperates with the guide groove 607.

An installation method of the post-processing equipment for 3D-printed plastic parts comprises the following steps: Step A: placing the reaction chamber 2 at the equipment housing 1 through the loading chamber 101, such that the retaining plate 201 of the reaction chamber 2 fits with the position of the carrier plate 404, and the retaining plate 201 is engaged to a side of the anti-slip strips 405 of the carrier plate 404 through the engaging groove 202; at this time, the connecting pipe 5 at the lower portion of the reaction chamber 2 is inserted into the connecting joint 603 of the guide cylinder 601; Step B: pressing the reaction chamber 2 downward through the chamber cover 3, so that the retaining plate 201 presses the connecting rods 403 through the carrier plate 404, the connecting rods 403 move toward the inner cavity 4021 and press the return spring 406, and the return spring 406 is compressed until the carrier plate 404 fits to the sliding plate 402; at this time, the retaining plate 201 is located below the notch 4012 of the retaining slide groove 401; Step C: rotating the reaction chamber 2, the retaining plate 201 rotates to the tail end of the guide rolling groove 4011 through the rolling balls 407 below the sliding plate 402, and the elastic force generated by the return spring 406 presses the retaining plate 201 to fit to the inner wall of the guide rolling groove 4011, thereby completing preliminary positioning of the reaction chamber 2; Step D: during pressing the reaction chamber 2 downward, the connecting support plate 501 of the connecting pipe 5 presses and fits to the receiving groove 605 position of the connecting joint 603 through the guide groove 607, and presses the sealing liner 606 therein; the sealing liner 606 elastically deforms to fill and satisfy the gap between the connecting pipe 5 and the connecting joint 603; Step E: the connecting joint 603 moves downward under force to drive the bellows 602 to fold, and meanwhile the connecting joint 603 presses the sealing spring 604; the sealing spring 604 generates an elastic force and acts on the connecting pipe 5 reversely through the connecting joint 603; Step F: during rotation of the reaction chamber 2, the connecting pipe 5 follows in the guide groove 607, driving the connecting support plate 501 to rotate into the positioning groove 6071 at the tail end of the guide groove 607; positioning of the connecting pipe 5 completes secondary positioning of the reaction chamber 2.

### OPERATING CONDITIONS AND EXAMPLES (Optional)

The post-processing equipment described herein may be used to perform chemical vapor smoothing and/or chemical vapor polishing of 3D-printed plastic parts. In some embodiments, the reaction chamber (2) is configured to receive a batch of 3D-printed plastic parts, and the parts are exposed to vaporized solvent within the reaction chamber (2) under controlled temperature and/or pressure conditions.

In some embodiments, solvent vapor may be generated by heating a solvent, by reducing pressure to promote evaporation, by atomization, or by a combination thereof. The solvent may be introduced into the reaction chamber (2) as vapor and/or generated within the equipment during operation.

In some embodiments, operating temperature may be selected based on the solvent and the plastic material being processed. By way of example and without limitation, an operating temperature may be within a range of about 20°C to about 120°C, or about 30°C to about 90°C. In some embodiments, the equipment may be operated at atmospheric pressure or under reduced pressure. By way of example and without limitation, an operating pressure may be within a range of about 10 kPa to about 101 kPa.

In some embodiments, exposure time of the parts to vaporized solvent may be selected based on desired surface finish and part geometry. By way of example and without limitation, an exposure time may be within a range of about 10 seconds to about 60 minutes, or about 1 minute to about 30 minutes.

In some embodiments, after vapor exposure, the parts may be subjected to a drying and/or curing stage to remove residual solvent. By way of example and without limitation, drying may be performed for about 1 minute to about 120 minutes, optionally with airflow and/or mild heating, depending on the solvent and material.

In some embodiments, the recovery chamber recovers vaporized solvent from the reaction chamber (2) via the connecting pipe (5). Recovery may be performed by condensing vaporized solvent (e.g., by cooling), by adsorption, by absorption, or by a combination thereof. Recovered solvent may be collected for reuse, disposal, or further processing.

Example 1 (Installation and Operation). A reaction chamber (2) loaded with 3D-printed plastic parts is installed into the equipment housing (1) through the loading chamber (101) according to Steps A–F described herein. During installation, the reaction chamber (2) is fixed by the retaining assembly (4) and the connecting pipe (5) is connected to the connecting joint (603) of the connecting assembly (6). After installation, a solvent is vaporized and introduced into the reaction chamber (2) to treat the parts. Vaporized solvent is transported through the connecting pipe (5) to the recovery chamber and recovered. After a selected treatment time, the parts are dried and removed.

Example 2 (Repeatable Installation). The reaction chamber (2) is repeatedly installed and removed for multiple batches. In each installation, the retaining plate (201) engages the carrier plate (404), and the connecting support plate (501) cooperates with the guide groove (607) to achieve positioning in the positioning groove (6071), thereby improving repeatability of installation and reducing alignment effort compared with bolt- or latch-based fastening.

The specific operating conditions provided above are examples only and are not intended to limit the scope of the present invention. Parameters may be adjusted based on solvent selection, part material, part geometry, and desired surface finish, and the equipment may be configured to include vacuum and/or temperature control modules.

Although the embodiments of the present invention have been shown and described, those of ordinary skill in the art will understand that various changes, modifications, substitutions, and variations may be made without departing from the principle and spirit of the present invention, and the scope of the present invention is defined by the appended claims and their equivalents.

1. A post-processing device for 3D-printed plastic parts, comprising:
an equipment housing having a loading chamber formed therein;
a reaction chamber disposed within the loading chamber and configured to accommodate 3D-printed plastic parts, an upper portion of the reaction chamber being provided with a chamber cover;
a retaining assembly arranged in the loading chamber and configured to secure the reaction chamber;
wherein a lower portion of the reaction chamber is connected to a recovery chamber via a connecting pipe, the recovery chamber being configured to recover solvent vapor generated in the reaction chamber;
wherein a connecting assembly is provided on the recovery chamber, such that the connecting pipe is connected to the recovery chamber through the connecting assembly; and
wherein, when the reaction chamber is secured within the loading chamber by the retaining assembly, the reaction chamber is simultaneously brought into fluid communication with the recovery chamber through the connecting assembly.

2. The post-processing device according to claim 1, wherein the retaining assembly comprises:
a retaining slide groove formed in the loading chamber;
a sliding plate disposed within the retaining slide groove;
a carrier plate connected to the sliding plate through two sets of connecting rods; and
a plurality of anti-slip strips arranged on the carrier plate.

3. The post-processing device according to claim 2, wherein:
the sliding plate defines an inner cavity, and a return spring is disposed in the inner cavity;
the return spring is positioned below the connecting rods such that the connecting rods are elastically movable within the inner cavity; and
a rolling groove is formed at a lower side of the sliding plate adjacent to the inner cavity, and rolling balls are embedded in the rolling groove.

4. The post-processing device according to claim 3, wherein:
an inner wall of the retaining slide groove is formed with a guide rolling groove configured to guide rolling of the rolling balls; and
a notch is formed at the retaining slide groove, the notch being configured to cooperate with the carrier plate.

5. The post-processing device according to claim 4, wherein:
a retaining plate is provided at an upper portion of the reaction chamber, the retaining plate having a shape corresponding to that of the carrier plate;
a bottom portion of the retaining plate is formed with engaging slots configured to engage with the anti-slip strips; and
a combined height of the sliding plate, the carrier plate, and the retaining plate corresponds to a height of the retaining slide groove.

6. The post-processing device according to claim 1, wherein the connecting assembly comprises:
a guide cylinder disposed within the equipment housing;
a bellows tube disposed inside the guide cylinder and connected to the recovery chamber; and
a connecting joint arranged at an upper portion of the bellows tube.

7. The post-processing device according to claim 6, wherein a sealing spring is disposed between the bellows tube and the guide cylinder, the sealing spring being positioned below the connecting joint.

8. The post-processing device according to claim 7, wherein:
a receiving groove configured to receive the connecting pipe is formed at an upper portion of the connecting joint;
a sealing liner is disposed in the receiving groove;
an L-shaped guide groove is formed at the receiving groove, the guide groove being arcuate; and
a positioning groove is formed at a terminal end of the guide groove.

9. The post-processing device according to claim 8, wherein a connecting support plate is disposed on an outer periphery of the connecting pipe, and the connecting support plate is configured to cooperate with the guide groove.

10. An installation method for the post-processing device, comprising:
placing the reaction chamber into the equipment housing through the loading chamber such that a retaining plate of the reaction chamber abuts a carrier plate of the retaining assembly, the retaining plate being engaged with anti-slip strips of the carrier plate, and the connecting pipe at a lower portion of the reaction chamber being inserted into a connecting joint of the connecting assembly;
pressing the reaction chamber downward via the chamber cover such that the retaining plate presses the carrier plate to drive connecting rods to move toward an inner cavity and compress a return spring until the carrier plate abuts a sliding plate, with the retaining plate positioned below a notch of a retaining slide groove;
rotating the reaction chamber such that the retaining plate is guided by rolling balls to move along a guide rolling groove, and an elastic force generated by the return spring presses the retaining plate against an inner wall of the guide rolling groove to complete preliminary positioning of the reaction chamber;
during downward movement of the reaction chamber, causing a connecting support plate of the connecting pipe to move along a guide groove and press the connecting pipe into a receiving groove of the connecting joint, thereby elastically deforming a sealing liner to fill a gap between the connecting pipe and the connecting joint;
causing the connecting joint to move downward to drive a bellows tube to fold and compress a sealing spring, such that an elastic force generated by the sealing spring is applied to the connecting pipe through the connecting joint; and
during rotation of the reaction chamber, guiding the connecting pipe to move along the guide groove and into a positioning groove at a terminal end of the guide groove, thereby completing secondary positioning of the reaction chamber.
